(19) United States
(12) Patent Application Publication
(10) Pub. No.: US 2024/0209234 A1
(43) Pub. Date: Jun. 27, 2024

(54) NON-SPHERICAL PRIMARY SILICA NANOPARTICLES AND THE USE THEREFOR

(71) Applicant: VERSUM MATERIALS US, LLC, TEMPE, AZ (US)

(72) Inventors: GERHARD JONSCHKER, HEPPENHEIM (DE); RENE LUTZ, BRENSBACH (DE); CHRISTOS KYRIAKOU, BURSTADT (DE)

(21) Appl. No.: 18/555,810

(22) PCT Filed: Apr. 14, 2022
(86) PCT No.: PCT/US2022/071708

§ 371 Date: Oct. 17, 2023

Related U.S. Application Data
(60) Provisional application No. 63/177,539, filed on Apr. 21, 2021.
(60) Provisional application No. 63/264,912, filed on Dec. 3, 2021.

(51) Int. Cl. C09G 1/02; C01B 33/145; C09K 3/14

(52) U.S. Cl. CPC C09G 1/02; C01B 33/145; C09K 3/1409; C01P 2004/03; C01P 2004/30; C01P 2004/64

(57) ABSTRACT

Processes of synthesizing non-spherical primary silica nanoparticles comprise reacting at least two organoalkoxysilanes with water in a reaction mixture comprising water-miscible organic solvent and alkaline catalyst under alkaline conditions. The at least two organoalkoxysilanes have different reaction speeds with water under alkaline conditions. Each organoalkoxysilane has a structure represented by: SiR¹R²R³R⁴ (I), wherein R¹, R², R³, and R⁴ are each independently selected from the group consisting of OR or R, wherein R is a substituted or unsubstituted linear or branched C₁-C₁₂ alkyl group, a C₃-C₈ cycloaliphatic group, a C₂-C₆ alkylene group, a halogen, or an aryl group, at least two, preferable at least three of R¹, R², R³, and R⁴ are OR; and at least one of the at least two organoalkoxysilanes has at least three of OR. A molar ratio of water (H₂O) and hydrolysable groups (OR) on the at least two organoalkoxysilanes is >0 and <3.0 or 2.0.

### CROSS REFERENCE TO RELATED APPLICATION(S)

This application claims the benefit of U.S. Provisional Patent Application No. 63/264,912 filed on Dec. 3, 2021, and U.S. Provisional Patent Application No. 63/177,539 filed on Apr. 21, 2021; which are incorporated herein by reference as if fully set forth.

### BACKGROUND OF THE INVENTION

The present disclosure relates to the production of non-spherical primary silica nanoparticles for use as an abrasive in CMP compositions.

In the semiconductor industry, chemical mechanical polishing (abbreviated as CMP) is a well-known technology applied in fabricating advanced photonic, microelectromechanical, and micro-electronic materials and devices, such as semiconductor wafers.

During the fabrication of materials and devices used in the semiconductor industry, CMP is employed to planarize metal and/or oxide surfaces. CMP utilizes the interplay of chemical and mechanical action to achieve the planarity of the to-be-polished surfaces. Chemical action is provided by a chemical composition, also referred to as CMP composition or CMP slurry. Mechanical action is usually carried out by a polishing pad which is typically pressed onto the to-be-polished surface and mounted on a moving platen. The movement of the platen is usually linear, rotational or orbital.

In a typical CMP process step, a rotating wafer holder brings the to-be-polished wafer in contact with a polishing pad. The CMP composition is usually applied between the to-be-polished wafer and the polishing pad.

The shape of CMP abrasives has substantial influence on their performance in the planarization process. Recently, it was found that non-spherically shaped particles can show higher removal rates and higher efficiency than round shaped particles, so research has focused on providing methods to produce non-spherically shaped particles in a reproducible manner.

The reproducible synthesis of non-spherically shaped particles however is far more complicated than that of spherically shaped particles known in the art. While size control is typically the only feature monitored and tailored during the synthesis of spherical particles, producing elongated and branched particles make it necessary to control the size of the branches in addition to the overall 3-dimensional structure. So, it is no surprise that the industry is looking for a cost-efficient way to control the shape and branching of elongated nanoparticle structures.

Typically, today these particles are made by a controlled aggregation process, in which the colloidal particle formation in at least one phase of the production is deliberately driven to an instable region so that the intermediately formed spherical nanoparticles start to agglomerate. Then, the particles are brought back to a stable region when the desired size and structure is formed. An example of a process is found in U.S. Pat. No. 8,529,787 to Fuso Chemical Co. Ltd.

Such processes, however, suffer from a significant drawback, which is the inability to self-regulate. Thus, it is a tedious endeavor to have to constantly monitor and steer the reaction under such highly unstable conditions. Moreover, such prior art methods can hardly produce a variety of different shapes and variations in the degree of branching.

Accordingly, there is a need in the art for a process of making elongated and branched CMP abrasive such as silicon oxide where it is possible to synthesize nanoparticles in a variety of shapes and sizes in a simple and reproducible manner.

### BRIEF SUMMARY OF THE INVENTION

The present invention satisfies this need by providing non-spherical primary silica nanoparticles and use the non-spherical primary silica nanoparticles as the abrasive in CMP process.

In one aspect, there is provided a process of synthesizing non-spherical primary silica nanoparticles, or non-spherical primary silica nanoparticles dispersion, wherein the process comprises:
a) providing a first mixture containing at least two organoalkoxysilanes and each having a structure of Formula I:

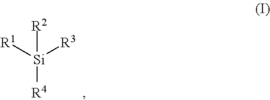

wherein R¹, R², R³, and R⁴ are each independently selected from the group consisting of OR or R, wherein R is a substituted or unsubstituted linear or branched C₁-C₁₂ alkyl group, a C₃-C₈ cycloaliphatic group, a C₂-C₆ alkylene group, a halogen, or an aryl group;
and at least two, preferably at least three of R¹, R², R³, and R⁴ are OR;
wherein at least one of the at least two organoalkoxysilanes has at least three of, preferably all R¹, R², R³, and R⁴ as OR; and
the at least two organoalkoxysilanes have different reaction speeds with water under alkaline conditions;
   b) providing a water-miscible organic solvent;
   c) providing an alkaline catalyst;
   d) obtaining a reaction mixture comprising a) to c); wherein the reaction mixture contains water and has a molar ratio (ROR) of water (H₂O) and hydrolysable groups (OR) on the at least two organoalkoxysilanes greater than 0, and below 3.0, or below 2.0; such as from 0.5 to 1.5, according to a formula: ROR=M(H₂O)/M(OR);
   e) forming non-spherical primary silica nanoparticles by reacting the at least two organoalkoxysilanes with the water in the reaction mixture under an alkaline condition;
      and
      optionally,
   f) replacing at least a portion of the water-miscible organic solvent by water after the non-spherical primary silica nanoparticles are formed to obtain a non-spherical primary silica nanoparticles dispersion; and
   g) adding water in step d) if there is not enough water from a) to c) to meet the ROR in step d).

The pH of the reaction mixture is generally in the range of 7 to 14, preferably 10 to 14, and more preferably 12 to 14.

Step d) can be performed by (1) adding the water-miscible organic solvent into the mixture of at least two organoalkoxysilanes to obtain a first mixture, and adding the alkaline catalyst into the first mixture; (2) adding the alkaline catalyst into the water-miscible organic solvent to obtain a first mixture, and adding the mixture of at least two organoalkoxysilanes into the first mixture; or (3) adding the water-miscible organic solvent into the mixture of at least two organoalkoxysilanes to obtain a first mixture, adding the water-miscible organic solvent into the alkaline catalyst to obtain a second mixture, and mixing the first and the second mixtures in a mixer in a flow reactor. Water can be added in the reaction mixture if there is not enough water in the mixture of a) to c).

The at least two organoalkoxysilanes include but are not limited to the group consisting of tetramethoxysilane, tetraethoxysilane, tetraisopropoxysilane, tetrabutoxysilane, tetraoctoxysilane, methyltrimethoxysilane, methyltriethoxysilane, methyltriisopropoxysilane, ethyltrimethoxysilane, ethyltriethoxysilane, ethyltriisopropoxysilane, octyltrimethoxysilane, octyltriethoxysilane, vinyltrimethoxysilane, vinyltriethoxysilane, phenyltrimethoxysilane, phenyltriethoxysilane, triethylmethoxysilane, fluorotriisopropoxysilane, fluorotrimethoxysilane, fluorotriethoxysilane, dimethyldimethoxysilane, dimethyldiethoxysilane, diethyldimethoxysilane, diethyldiethoxysilane, trimethylmethoxysilane, trimethylethoxysilane, trimethylisopropoxysilane, trimethylbutoxysilane trifluoromethyltrimethoxysilane, and trifluoromethyltriethoxysilane. The preferred at least two organoalkoxysilanes comprise tetramethoxysilane (TMOS) and tetraethoxysilane (TEOS).

In one embodiment where there are two organoalkoxysilanes, the first organoalkoxysilane may be present from about 50 to about 99 mole % and the second organoalkoxysilane may be present at from about 50 to about 1 mole %. In another embodiment, the first organoalkoxysilane may be present from about 75 to about 95 mole % and the second organoalkoxysilane may be present at from about 5 to about 25 mole %. In another embodiment, the first organoalkoxysilane may be present from about 85 to about 90 mole % and the second organoalkoxysilane may be present at from about 15 to about 10 mole %. The mole % is based on the total mole of the two organoalkoxysilanes is 100%.

The first mixture, the second mixture and the reaction mixture can be heated and maintained at a temperature from 30° C. to 70° C., from 40° C. to 60° C., or from 48° C. to 52° C.

The non-spherical primary silica nanoparticles is produced at a yield of at least 50%, 75% or 85% based on total weight of particles produced in the process.

The non-spherical primary silica nanoparticles is produced at a weight % yield 3.0 wt. %-8.0 wt. %, 4.0 wt. %-7.0 wt. %, 4.5 wt. %-6.5 wt. %, 5.5 wt. %-6.5 wt. %. The weight % yield is based on the total weight of silica nanoparticles which can be produced by the total weight of the reaction mixture.

The non-spherical primary silica nanoparticles have shapes selected from the group consisting of elongated, bent, branched, and combinations thereof, and contain a nitrogen level (or nitrogen content) of <0.2, 0.1, 0.02, 0.01, 0.006, 0.005, or 0.004 mmol/g SiO₂.

In another aspect, there is provided non-spherical primary silica nanoparticles or non-spherical primary silica nanoparticles dispersion, wherein the non-spherical primary silica nanoparticles have shapes selected from the group consisting of elongated, bent, branched, and combinations thereof, and contain a nitrogen level (or nitrogen content) of <0.2, 0.1, 0.02, 0.01, 0.006, 0.005, or 0.004 mmol/g SiO₂.

In yet another aspect, there is provided a Chemical Mechanical Planarization (CMP) composition comprising: non-spherical primary silica nanoparticles or non-spherical primary silica nanoparticles dispersion, wherein the non-spherical primary silica nanoparticles have shapes selected from the group consisting of elongated, bent, branched, and combinations thereof, and contain a nitrogen level (or nitrogen content) of <0.2, 0.1, 0.02, 0.01, 0.006, 0.005, or 0.004 mmol/g SiO₂.

### BRIEF DESCRIPTION OF SEVERAL VIEWS OF THE DRAWINGS

FIG. 1 is a Scanning Electron Microscopes (SEM) micrograph at 20,000× of the non-spherical primary silica nanoparticles produced by Example 2;

FIG. 2 is a SEM micrograph at 100,000× of the non-spherical primary silica nanoparticles produced by Example 2;

FIG. 3 is a SEM micrograph at 20,000× of the non-spherical primary silica nanoparticles produced by Example 3;

FIG. 4 is a SEM micrograph at 100,000× of the non-spherical primary silica nanoparticles produced by Example 3;

FIG. 5 is a SEM micrograph at 20,000× of the non-spherical primary silica nanoparticles produced by Example 4; and

FIG. 6 is a SEM micrograph at 100,000× of the non-spherical primary silica nanoparticles produced by Example 4.

### DETAILED DESCRIPTION OF THE INVENTION

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

As used herein and in the claims, the terms “comprising,” “comprises,” “including,” and “includes” are inclusive or open-ended and do not exclude additional unrecited elements, composition components, or process steps. Accordingly, these terms encompass the more restrictive terms “consisting essentially of” and “consisting of.” Unless specified otherwise, all values provided herein include up to and including the endpoints given, and the values of the constituents or components of the compositions are expressed in weight percent of each ingredient in the composition.

Embodiments are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The terms “nanoparticle(s)” and “colloid(s)” are synonymous and denote particles whose size is between 1 and 1000 nanometers.

As used herein, “about” is intended to correspond to +5% of the stated value.

In all such compositions, wherein specific components of the composition are discussed in reference to weight percentage ranges including a zero lower limit, it will be understood that such components may be present or absent in various specific embodiments of the composition, and that in instances where such components are present, they may be present at concentrations as low as 0.00001 weight percent, based on the total weight of the composition in which such components are employed.

The term “non-spherical silica nanoparticles” refers to both non-spherical silica primary nanoparticles, and non-spherical silica secondary nanoparticles

The term “non-spherical” used herein includes all shapes or structures that are not spherical. It includes but not limited to “elongated”, “bent structure” and “branched structure”, and combinations thereof.

The term “non-spherical primary silica nanoparticles” refers to a primary silica particle having a structure in which the silica grows in a shape of non-linear, elongated, bent, branched, or combinations. More specifically, the term refers to a structure that the silica particles grow inhomogeneously in more than one direction at the same time and thereby producing a non-spherical structure.

In contrast to a non-spherical primary silica nanoparticle, a spherical primary silica nanoparticle refers to a structure when the silica particle grow homogeneously in all directions and thereby producing a spherical structure.

The term “non-spherical primary silica nanoparticles” do not include the aggregated particles, or aggregated primary particles, or aggregated spherical primary particles.

The present invention provides a process of synthesizing non-spherical primary silica nanoparticles using at least two organoalkoxysilanes at the same time, where the chosen organoalkoxysilanes have different reaction speeds with water under alkaline conditions.

Specifically, the present invention provides a process of synthesizing non-spherical primary silica nanoparticles or non-spherical primary silica nanoparticles dispersion; wherein the process comprises the following steps:
a) providing a first mixture of at least two organoalkoxysilanes and each organoalkoxysilane independently has a structure represented by Formula I:

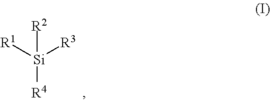

wherein
R¹, R², R³, and R⁴ are each independently selected from the group consisting of OR or R, wherein R is a substituted or unsubstituted linear or branched C₁-C₁₂ alkyl group, a C₃-C₈ cycloaliphatic group, a C₂-C₆ alkylene group, a halogen, or an aryl group, and at least two, preferably at least three of the R¹, R², R³, and R⁴ are OR;
wherein at least one of the at least two organoalkoxysilanes having at least three of, preferably all R¹, R², R³, and R⁴ as OR;
and the at least two organoalkoxysilanes have different reaction speeds with water under alkaline conditions;
b) providing a water-miscible organic solvent;
c) providing an alkaline catalyst;
d) obtaining a reaction mixture comprising a) to c); wherein the reaction mixture contains water and has a molar ratio (ROR) of water (H₂O) and hydrolysable groups (OR) on the at least two organoalkoxysilanes greater than 0, and below 3.0, or below 2.0; such as from 0.5 to 1.5, according to a formula: ROR=M(H₂O)/M(OR);
e) forming non-spherical primary silica nanoparticles by reacting the at least two organoalkoxysilanes with the water in the reaction mixture under an alkaline condition;
   and
   optionally,
f) replacing at least a portion of the water-miscible organic solvent by water after the non-spherical primary silica nanoparticles are formed to obtain a non-spherical primary silica nanoparticles dispersion; and
g) adding water in step d) if there is not enough water from a) to c) to meet the ROR in step d).

The pH of the reaction mixture is generally in the range of 7 to 14, preferably 10 to 14, and more preferably 12 to 14.

Step d) can be performed by (1) adding the water-miscible organic solvent into the mixture of at least two organoalkoxysilanes to obtain a first mixture, and adding the alkaline catalyst into the first mixture; (2) adding the alkaline catalyst into the water-miscible organic solvent to obtain a first mixture, and adding the mixture of at least two organoalkoxysilanes into the first mixture; or (3) adding the water-miscible organic solvent into the mixture of at least two organoalkoxysilanes to obtain a first mixture, adding the water-miscible organic solvent into the alkaline catalyst to obtain a second mixture, and mixing the first and the second mixtures in a mixer in a flow reactor. Water can be added in the reaction mixture if there is not enough water in the mixture of a) to c).

The at least two organoalkoxysilanes include but are not limited to the group consisting of tetramethoxysilane, tetraethoxysilane, tetraisopropoxysilane, tetrabutoxysilane, tetraoctoxysilane, methyltrimethoxysilane, methyltriethoxysilane, methyltriisopropoxysilane, ethyltrimethoxysilane, ethyltriethoxysilane, ethyltriisopropoxysilane, octyltrimethoxysilane, octyltriethoxysilane, vinyltrimethoxysilane, vinyltriethoxysilane, phenyltrimethoxysilane, phenyltriethoxysilane, triethylmethoxysilane, fluorotriisopropoxysilane, fluorotrimethoxysilane, fluorotriethoxysilane, dimethyldimethoxysilane, dimethyldiethoxysilane, diethyldimethoxysilane, diethyldiethoxysilane, trimethylmethoxysilane, trimethylethoxysilane, trimethylisopropoxysilane, trimethylbutoxysilane trifluoromethyltrimethoxysilane, and trifluoromethyltriethoxysilane. The preferred at least two organoalkoxysilanes comprise tetramethoxysilane and tetraethoxysilane.

The preferred at least two organoalkoxysilanes comprise tetramethoxysilane and tetraethoxysilane.

The concentrations (mole %) of the at least two organoalkoxysilanes can be any value.

In one embodiment where there are two organoalkoxysilanes, the first organoalkoxysilane may be present from about 50 to about 99 mole % and the second organoalkoxysilane may be present at from about 50 to about 1 mole %. In another embodiment, the first organoalkoxysilane may be present from about 75 to about 95 mole % and the second organoalkoxysilane may be present at from about 5 to about 25 mole %. In another embodiment, the first organoalkoxysilane may be present from about 85 to about 90 mole % and the second organoalkoxysilane may be present at from about 15 to about 10 mole %. The mole % is based on the total mole of the two organoalkoxysilanes is 100%.

The first mixture, the second mixture and the reaction mixture can be heated and maintained at a temperature from 30° C. to 70° C., from 40° C. to 60° C., or from 48° C. to 52° C.

The non-spherical primary silica nanoparticles is produced at a yield of at least 50%, 75% or 85% based on total weight of particles produced in the process. That is, 50%, 75% or 85% of the total particles produced in the process are non-spherical primary silica nanoparticles.

The non-spherical primary silica nanoparticles is produced at a weight % yield of 3.0 wt. %-8.0 wt. %, 4.0 wt. %-7.0 wt. %, 4.5 wt. %-6.5 wt. %, 5.5 wt. %-6.5 wt. %. The weight % yield is based on the total weight of silica nanoparticles which can be produced by the total weight of the reaction mixture.

The non-spherical primary silica nanoparticles have shapes selected from the group consisting of elongated, bent, branched, and combinations thereof, and contain a nitrogen level (or nitrogen content) of <0.2, 0.1, 0.02, 0.01, 0.006, 0.005, or 0.004 mmol/g SiO₂.

Again, the term “non-spherical primary nanoparticles” do not include the aggregated particles, such as aggregated primary particles.

The process disclosed herein allows the degree of elongation, bending, and/or branching to be tailored to the desired degree.

The components of the reaction mixture and the reaction process will be described in detail herein.

### Organoalkoxysilane

The Stöber process is a well-known prior art process for making spherically-shaped silica particles. In the Stöber process, tetraethyl orthosilicate (TEOS) is added to a solution of excess water, alcohol and ammonium hydroxide under agitation to form spherically shaped nanoparticles. The process of the present invention, however, comprises modifications to the Stöber process that led to a surprising and unexpected result of non-spherical primary silica nanoparticles.

Namely, the process of the present invention comprises the step of reacting at least two organoalkoxysilanes with water in a reaction mixture.

Each of the at least two organoalkoxysilane independently has a structure represented by Formula I shown below:

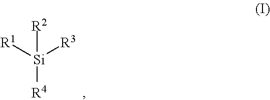

wherein
R¹, R², R³, and R⁴ are each independently selected from the group consisting of OR or R, wherein R is a substituted or unsubstituted linear or branched C₁-C₁₂ alkyl group, a C₃-C₈ cycloaliphatic group, a C₂-C₆ alkylene group, a halogen, or an aryl group, wherein at least two. preferably at least three of R¹, R², R³, and R⁴ is OR.

At least one of the at least two organoalkoxysilanes has at least three of, preferably all, R¹, R², R³, and R⁴ as OR.

Examples of organoalkoxysilanes represented by the Formula I include tetramethoxysilane(TMOS), tetraethoxysilane (TEOS), tetraisopropoxysilane, tetrabutoxysilane, tetraoctoxysilane, methyltrimethoxysilane (MTMS), methyltriethoxysilane, methyltriisopropoxysilane, ethyltrimethoxysilane, ethyltriethoxysilane, ethyltriisopropoxysilane, octyltrimethoxysilane, octyltriethoxysilane, vinyltrimethoxysilane, vinyltriethoxysilane, phenyltrimethoxysilane, phenyltriethoxysilane, triethylmethoxysilane, fluorotriisopropoxysilane, fluorotrimethoxysilane, fluorotriethoxysilane, dimethyldimethoxysilane, dimethyldiethoxysilane, diethyldimethoxysilane, diethyldiethoxysilane, trimethylmethoxysilane, trimethylethoxysilane, trimethylisopropoxysilane, trimethylbutoxysilane trifluoromethyltrimethoxysilane, and trifluoromethyltriethoxysilane.

The at least two organoalkoxysilanes should be deliberately selected to have different reaction speeds with water in alkaline conditions. Thus, SiO₂ seed formation by each organoalkoxysilane starts at different times.

Without intending to be bound by any particular theory, talking two organoalkoxysilanes in the reaction of the present invention as an example, the organoalkoxysilane having a faster speed of reaction reacts first with water to form silanols and subsequently SiO₂ seeds according to the well-established LaMer theory. While these seeds are beginning to grow, the other organoalkoxysilane having a slower speed of reaction starts producing new silanols which also create subsequently new seeds. Thus, the seed formation and particle growth reactions are taking place at the same time due to the different reaction speeds of the two organoalkoxysilanes with water. A new seed can be growing by itself or a new seed can be attached to a growing seed to form another seed. The seed formation and growth are no longer separated due to the interferences of the reactions of two organoalkoxysilanes, thus stipulate inhomogenous growth of particles in all dimensions. As a result, the process in present invention forms a surprising and unexpected result of non-spherical primary silica nanoparticles.

The process is unique because at least two organoalkoxysilanes having different reaction speeds with water under alkaline conditions are used at the same time comparing with the known processes where only one organoalkoxysilane is used, or is used at one time.

In one embodiment where there are two organoalkoxysilanes, the first organoalkoxysilane may be present from about 50 to about 99 mole % and the second organoalkoxysilane may be present at from about 50 to about 1 mole %. In another embodiment, the first organoalkoxysilane may be present from about 75 to about 95 mole % and the second organoalkoxysilane may be present at from about 5 to about 25 mole %. In another embodiment, the first organoalkoxysilane may be present from about 85 to about 90 mole % and the second organoalkoxysilane may be present at from about 15 to about 10 mole %. The mole % is based on the total mole of the two organoalkoxysilanes is 100%.

In some embodiments, the at least two organoalkoxysilanes are TEOS and TMOS. In embodiments, the TEOS is present from about 75 to about 98 mole % and the TMOS is present from about 2 to about 25 mole %, more preferable the TEOS is present from about 85 to about 95 mole % and the TMOS is present from about 5 to about 15 mole %, and most preferably the TEOS is present from about 88 to about 92.5 mole % and the TMOS is present from about 7.5 to about 12 mole %. For example, in one embodiment, the TEOS is present at 90 mole % and the TMOS is present at 10 mole %.

### Water

Water is a reactant in the process of the present invention. In contrast to what was known in the art regarding the Stöber process, the inventors have discovered that the effect on the shape of the silica nanoparticles can be influenced by the amount of water present in the reaction mixture in addition to the different speed of reaction of at least two organoalkoxysilanes. Although the literature typically teaches use of an excess of water in the Stöber process, excess water used with the mixture of at least two organoalkoxysilanes only leads to small deviations from the spherical shape. The inventors have discovered that more pronounced deviations are observed if less water is used for the hydrolysis reaction in the current process. Preferably, the water content is present at a molar ratio, ROR of below 3 or below 2, wherein the ROR is defined as the molar ratio of water and hydrolysable groups of the organoalkoxysilanes defined as ROR=M(H₂O)/M(OR). Most preferably the ROR is between 0.5 (stoichiometrically minimum for complete hydrolysis and condensation) and 1.0.

It is preferred to use the water of the catalyst solution as the sole source of water, such as 25-35% ammonia solution in water.

Water can be added to the reaction mixture if a catalyst solution used in the process does not contain or does not have enough water.

### Water-Miscible Organic Solvent

A water-miscible organic solvent is used in the process of the present invention.

Examples of the organic solvent include an alcohol, a ketone, an ether, a glycol, and an ester, with an alcohol being preferred. More particularly, alcohols such as methanol, ethanol, propanol, and butanol; ketones such as methyl ethyl ketone and methyl isobutyl ketone; glycol ethers such as propylene glycol monopropyl ether; glycols such as ethylene glycol, propylene glycol, and hexylene glycol; and esters such as methyl acetate, ethyl acetate, methyl lactate, and ethyl lactate are preferred. Among them, methanol or ethanol is more preferred, and ethanol is particularly preferred. These water-miscible organic solvents may be used alone or in a mixture of two or more.

The water-miscible organic solvent is preferably used in the reaction mixture in an amount of from about 25 to about 95% by weight of the reaction mixture total weight. In other embodiments, the water-miscible organic solvent is used from 40 wt. % to about 90 wt. %, or from about 50 wt. % to about 80 wt. % by weight of the reaction mixture.

### Alkaline Catalyst

At least one alkaline catalyst is used in the process of the present invention.

The alkaline catalyst is selected from the group consisting of ammonia (NH₃), ammonium hydroxide, an organic amine, an alkanolamine, a quaternary ammonium hydroxide compound, and combinations thereof.

Preferred alkaline catalysts include ammonia (NH₃) or at least one organic amine.

Examples of suitable organic amines for use as the at least one alkaline catalyst include hexyl amine, 5-amino-2-methyl pentane, heptyl amine, octyl amine, nonyl amine, decyl amine, dipropyl amine, diisopropyl amine, dibutyl amine, diisobutyl amine, di-n-butyl amine, di-t-butyl amine, dipentyl amine, dihexyl amine, diheptyl amine, dioctyl amine, dinonyl amine, didecyl amine, amyl methyl amine, methyl isoamyl amine, tripropyl amine, tributyl amine, tripentyl amine, dimethyl ethyl amine, methyl diethyl amine, methyl dipropyl amine, N-ethylidene methyl amine, N-ethylidene ethyl amine, N-ethylidene propyl amine, N-butyl amine ethylidene, alkanolamines, ethanolamine, N-methyl ethanolamine, N-ethyl ethanolamine, N-propyl ethanolamine, N-butyl ethanolamine, diethanolamine, 1-amino-2-propanol, N-methyl amine isopropanol, N-ethyl-isopropanol amine, N-propyl isopropanol amine, 2-aminopropane-1-ol, N-methyl-2-aminopropane-1-ol, N-ethyl-2-aminopropane-1-ol, 1-aminopropane-3-ol, N-methyl-1-aminopropane-3-ol, N-ethyl-1-aminopropane-3-ol, 1-aminobutane-2-ol, N-methyl-1-aminobutane-2-ol, N-ethyl-1-aminobutane-2-ol, 2-aminobutan-1-ol, N-methyl-2-aminobutane-1-ol, N-ethyl-2-aminobutane-1-ol, N-hydroxy-methyl ethanol amine, N-hydroxymethyl ethylene diamine, N,N′-bis (hydroxymethyl) ethylene diamine, N-hydroxymethyl propanol amine, ethylene diamine, propylene diamine, trimethylene diamine, tetramethylene diamine, 1,3-diaminobutane, 2,3-diaminobutane, pentamethylene diamine, 2,4-diamino pentane, hexamethylene diamine, heptamethylene diamine, octamethylene diamine, nonamethylene diamine, N-methyl ethylene diamine, N,N-dimethyl ethylene diamine, trimethyl ethylene diamine, N-ethyl ethylene diamine, N, N-diethyl ethylene diamine, triethyl ethylene diamine, 1,2,3-triaminopropane, hydrazine, tris (2-aminoethyl) amine, tetra (aminomethyl) methane, diethylene triamine, triethylene tetramine, tetraethyl pentamine, heptaethylene octamine, nonaethylene decamine, diazabicyclo undecene, hydroxylamine, N-methyl hydroxylamine, N-ethyl hydroxylamine, N,N-diethyl hydroxylamine, oligo- and polyethylenimines and mixtures thereof.

Examples of suitable alkanolamines include primary, secondary and tertiary alkanolamines having from 1 to 5 carbon atoms such as, for example, N-methylethanolamine (NMEA), monoethanolamine (MEA), N-methyl diethanolamine, diethanolamine, mono-, di- and triisopropanolamine, 2-(2-aminoethylamino) ethanol, 2-(2-aminoethoxy) ethanol, triethanolamine, and mixtures thereof. In one embodiment, the alkanolamine is selected from the group consisting of triethanolamine (TEA), diethanolamine, N-methyl diethanolamine, diisopropanolamine, N-methyl ethanol amine, and mixtures thereof.

Examples of suitable quaternary ammonium hydroxide compounds for use as the at least one alkaline catalyst include tetramethylammonium hydroxide (TMAH), tetraethylammonium hydroxide, tetrabutylammonium hydroxide (TBAH), tetrapropylammonium hydroxide, trimethylethylammonium hydroxide, (2-hydroxyethyl) trimethylammonium hydroxide, (2-hydroxyethyl)triethylammonium hydroxide, (2-hydroxyethyl)tripropylammonium hydroxide, (1-hydroxypropyl)trimethylammonium hydroxide, ethyltrimethylammonium hydroxide, diethyldimethylammonium hydroxide and benzyltrimethylammonium hydroxide, or mixtures thereof.

The amount of the alkaline catalyst added to the reaction mixture may be appropriately adjusted so that the pH of the reaction mixture is maintained in the range of 7 to 14, preferably 10 to 14, and more preferably 12 to 14.

The alkaline catalyst can be added to the mixture of at least two organoalkoxysilanes and the water-miscible organic solvent; or can be added to the water-miscible organic solvent first and then add into the mixture of at least two organoalkoxysilanes to obtain a reaction mixture.

In a preferred embodiment, the alkaline catalyst is added to the mixture of at least two organoalkoxysilanes and the water-miscible organic solvent while stirring to obtain the reaction mixture. The catalyst can be present as aqueous solution such as 25%-35% solution of ammonia in water, so that water as a reactant is added at the same time like the catalyst.

The addition of the catalyst can be slow or all at once. Preferably, the catalyst is added quickly under vigorous stirring to a pre-heated silane/solvent mixture.

A typical reaction time is from 1 to 5 hours. Preferably, both silane/solvent mixture and the catalyst are heated. Still more preferably, both are heated to the same temperature prior to mixing. Exemplary temperatures include those in the range of from 30° C. to 70° C., from 40° C. to 60° C., and from 48° C. to 52° C.

The process should be designed in a way to avoid the evaporation of volatile catalysts (such as NH₃) from the reaction mixture. A continuous pipe/flow reactor or a batch reactor with a sufficiently long pipe can be used to ensure that the reaction proceeds to a desired extent (particle formation).

When the reaction is performed in the presence of a nitrogen-containing alkaline catalyst, nitrogen compounds may be trapped inside the colloidal silica abrasive particles during particle growth, thus resulting in colloidal silica abrasive particles comprising nitrogen-containing compounds internally incorporated within the colloidal silica abrasive particles. A nitrogen level or nitrogen content (milli molar/gram silica or mmol/g silica) can be used to measure the nitrogen contained in the particles.

Because the process of the present invention is performed with less water relative to a typical Stöber process, in some embodiments, excess water may be added after the reaction is complete or is almost complete while stirring for 1 to 60 minutes to ensure that all reaction sites on the organoalkoxysilanes are exhausted. Preferably, the excess water is added to achieve a ROR value of at least ≥1.0, most preferably ≥2.0. Due to the unique way of particle growth, the colloidal silica produced by the process of the present invention having a non-spherical, elongated, bent and branched structures can be obtained.

Optionally, depending on the desired characteristics of the colloidal silica particles, a second growth step can be performed. For example, in one embodiment, the process of the present invention further comprises the step of adding at least an organoalkoxysilane and water and, optionally, more of the alkaline catalyst to the reaction mixture. Although more than one organoalkoxysilane can be added, it is preferred that the optional second growth step is performed with only one organoalkoxysilane compound such as, for example, TEOS. The addition rate for the second step is preferably drop-wise addition of the organoalkoxysilane to maintain the pH of the liquid mixture at ≥7, preferably, from 12 to 14. The addition rate of the organoalkoxysilane for the optional second growth step is preferably 0.7 to 41 g of silica/hour/kg of the reaction mixture.

A next step of the process of the present invention comprises exchanging at least a portion of the water-soluble organic solvent for water once the non-spherical primary silica nanoparticles are formed to obtain a dispersion of the silica nanoparticles in water. Such solvent exchange step can use any know process for exchanging organic solvent for water such as, for example, distillation or cross-flow filtration. The solvent exchange step preferably is performed until as much of the organic solvent as possible is removed subject to any inherent limitation of the process employed. Preferably, the exchanging step comprises adding water in an amount to achieve a molar ratio of water and hydrolysable groups on the organoalkoxysilanes (ROR) of greater than or equal to 2.0. When the solvent exchange is done by distillation, it is preferred to add diluted ammonia solution (1-15% NH₃ in water) instead of pure water during at least a part of the process to ensure that the pH never falls under pH 8 which might impact colloidal stability.

In a preferred embodiment, the dispersion resulting after the solvent exchange step is concentrated by any suitable means to obtain a solid concentration of from 15 to 25% or more.

The process of the present invention may include other optional steps, such as chemically modifying the surface of the produced colloidal silica. There are important features of the silica surface that will influence the etch rates and final surface conditions. The typical silica surface is terminated (covered) with —OH groups under neutral or basic conditions. The silica surface is hydrophilic and, thus, “wettable.” These groups activate the surface to a number of possible chemical or physioabsorbtion phenomena. The Si—OH groups impart a weak acid effect which allows for the formation of salts and to exchange the proton (H⁺) for various metals (similar to the ion exchange resins). These Si—O and Si—OH can also act as ligands for complexing Al, Fe, Cu, Sn and Ca. Of course, the surface is very dipolar and so electrostatic charges can accumulate or be dissipated depending on the bulk solution's pH, ion concentration and charge. This accumulated surface charge can be measured as the Zeta potential.

The CMP liquid containing abrasive particles may need to undergo a pH adjustment, for example where a high zeta potential is attainable to retain colloidal stability. It is undesirable in an abrasive-containing liquid for the particles to settle out of the suspension. Electrical charges surrounding the interface between the particle and the liquid strongly influence the stability of the colloidal system. The Zeta potential measures the potential of a particle's surface at its shear plane and provides a general measure of the stability of a colloidal system. To maintain a stable colloidal system, a high Zeta potential of either positive or negative charge is desired. The Zeta potential of the particular particle decreases to zero at the pH corresponding to its isoelectric point. Thus, to enhance the stability of the colloid, the pH of the system should differ from the pH at the isoelectric point. For example, the isoelectric point of a silica slurry is at a pH of 2; preferably, then, the silica slurry is maintained at an alkaline pH to enhance the colloidal stability. Other variables which affect the colloidal stability of a particulate system include particle density, particle size, particle concentration, and chemical environment.

Thus, the optional step of chemically modifying the surface of the produced colloidal silica can include any surface modification to adjust the Zeta potential of the colloidal dispersion or to impart any other desired functionality to the surface of the colloidal silica. The colloidal silica particles can be surface-modified using any suitable process as is known in the art. This includes modifying the surface of the colloidal silica by adding metal ions, boron, aluminum etc. The optional modifying step also includes treatment with surface-modifying agents such as silanes, including amino-containing silanes, sulfur-containing silanes, carboxy-group containing silanes, phosphorous-containing silanes, alkyl silanes, and the like.

In an embodiment, the step of modifying a surface of the non-spherical silica nanoparticles comprises replacing at least a portion of surface silanol groups with at least one selected from the group consisting of an organosilane, an organic polymer, an inorganic polymer, a surfactant, and an inorganic salt.

In preferred embodiments, the step of modifying a surface of the non-spherical silica nanoparticles comprises replacing at least a portion of surface silanol groups with the organosilane selected from the group consisting of an amino-functional alkoxysilane, a cyanofunctional alkoxysilane, an alkyl- and aryl-functional alkoxysilane, a sulfursilane, and a phosphorsilane. Examples of sulfursilanes include mercaptopropyltriethoxysilane, mercaptopropyltrimethoxysilane, and bis[3-(triethoxysilyl)propyl]polysulfide (Reg. tradename “Si 69” by Evonik). Examples of phosphorsilanes include N-diphenylphosphoryl-3-aminopropyltriethoxysilane, 3-(trihydroxysilyl)propyl methylphosphonate (ammonium salt), and 2-(diethylphosphatoethyl)methyldiethoxysilane.

In some applications, it may be preferable that the pH of the dispersion is acidic. This may be accomplished by any means known to those skilled in the art such as, for example, by passing the colloidal silica dispersion through an ion exchange resin until present cations are exchanged by H⁺ ions or by addition of a suitable acid. Such ion exchange can be performed either before or after the optional surface modification step.

Various particle stabilizing additives can be added to the dispersion. These include surfactant compounds. Suitable surfactant compounds include, for example, any of the numerous nonionic, anionic, cationic or amphoteric surfactants known to those skilled in the art. The surfactant compounds may be present in the slurry composition in a concentration of about 0 weight % to about 1 weight % and, when present, are preferably present in a concentration of about 0.001 weight % to about 0.1 weight % of the total weight of the slurry.

Other compounds can be added to the dispersions prepared herein, depending on the particular end use. These include chelating agents, corrosion inhibitors, colloidal stabilizers, organic or inorganic salts, and biological agents such as bactericides, biocides and fungicides.

### The Silica Nanoparticles Produced

The silica nanoparticles produced herein mainly comprise non-spherical primary silica particles, i.e., they are elongated and/or bent and/or branched particles. Preferably, the non-spherical primary silica nanoparticles comprise about 75%, 85%, or greater of the silica nanoparticles produced according to the inventive process disclosed herein.

An important point of the production process for non-spherical primary nanoparticles from a commercial view is the yield. The yield is defined as the total weight of silica nanoparticles which can be produced by the total weight of the reaction mixture and is typically reported as weight % yield.

Typical Stöber processes are very limited in their yield since attempts to achieve higher yields always lead to uncontrolled aggregation, precipitation or inhomogeneous size distributions. So, Stöber processes are typically performed at yields of 1-3% which means that most of the reaction mixture is solvent which needs to be removed in expensive downstream processes.

The described process of producing non-spherical primary silica nanoparticles shows a unique advantage in that it can be performed at much higher yields, yields which would not be possible with the already known Stöber processes which are described in the state of the art.

The described process can be done at yields ranging from 0.5-15%, preferably from 3%-8% and most preferably from 5% to 7% yield, which is a huge advantage meaning that about only half the amount of solvent is needed compared to Stöber processes known in the state of the art. So, in downstream processing also only half the amount of solvent has to be exchanged against water or removed.

The working examples in the application have shown the yields from 4.5-6.5%, or 5.5 to 6.5%.

The non-spherical primary silica particles might come into contact with each other and form some kind of bond like hydrogen-bridges or covalent bonds and aggregate to form secondary particles. The silica secondary particles mostly are non-spherical, or have elongated, bent structure, and/or a branched structure.

The term “aspect ratio” refers to a ratio of the major axis to the minor axis of the particles. Preferably, the non-spherical primary silica nanoparticles produced according to the process disclosed herein have an average value of the aspect ratio of the particles (an average aspect ratio) observed in the above view is preferably 1.5 or more and, more preferable, less than 5. If the average aspect ratio exceeds 5, handling thereof will be difficult due to the increase in viscosity etc., and gelation may occur.

The non-spherical primary silica nanoparticles can have an mean particle size of about 15 nm to 200 nm, about 20 nm to about 200 nm, about 20 nm to about 150 nm, about 20 nm to about 120 nm, about 20 nm to about 110 nm, about 20 nm to about 110 nm, about 30 nm to about 110 nm, about 30 nm to about 100 nm, about 30 nm to about 90 nm, about 30 nm to about 80 nm, or about 40 nm to 70 nm. Alternatively, or in addition, the non-spherical primary silica nanoparticles can have an mean particle size of about ≥10 nm, about ≥15 nm, and about ≤ 200 nm, about ≤ 150 nm, about ≤ 120 nm, about ≤100 nm, about <90 nm, about ≤ 80 nm, or about ≤ 70 nm. Thus, the non-spherical primary silica nanoparticles can have an mean particle size bounded by any two of the aforementioned endpoints.

The non-spherical silica secondary nanoparticles can have any suitable mean particle size. For example, the non-spherical silica secondary nanoparticles can have an mean particle size of about 15 nm to 600 nm, about 20 nm to 600 nm, about 25 nm to 550 nm, about 30 nm to 500 nm, about 35 nm to 450 nm, about 40 nm to 400 nm, about 45 nm to 350 nm, about 50 nm to 300 nm, or about 50 nm to 200 nm. Alternatively, or in addition, the non-spherical silica secondary nanoparticles can have an mean particle size of about ≥15 nm and ≤600 nm, about ≤500 nm, about ≤400 nm, about ≤300 nm, or about ≤200 nm. Thus, the silica nanoparticles can have an mean particle size bounded by any two of the aforementioned endpoints. It is preferred that the inventive non-spherical primary particles are not or only to a small extend aggregated to form secondary particles.

Thus, in another embodiment, the present invention provides non-spherical primary silica nanoparticles prepared by the process disclosed above.

Further, the inventive non-spherical primary silica nanoparticles have a bent and/or branched structure, and thus a large aspect ratio. Since the inventive elongated/bent/aggregated primary silica particles are superimposed over or entangled with one another, they exhibit excellent coating properties, and can therefore improve the coating properties when used as a vehicle for aqueous coating compositions.

The non-spherical primary silica nanoparticles produced herein are an excellent abrasive for use in CMP compositions as they exhibit high removal rates and high efficiency as compared to spherically-shaped particles. Accordingly, in another embodiment, provided herein is a CMP composition comprising the non-spherical primary silica nanoparticles produced according to the process disclosed herein.

Due to the unprecedented complex structure of the inventive particles, when the non-spherical primary silica nanoparticles are used as a polishing material, the contact resistance between the polishing material and a surface to be polished can be adjusted to thereby improve the polishing rate.

Hereinafter, the present invention is described in further detail with reference to the Examples and Comparative Example. However, the present invention is not limited thereto.

### EXAMPLES

### Example 1: Synthesis of Elongated Particles (5% TMOS 95% TEOS, ROR 0.75)

1204.96 mmol ethanol are heated under stirring to 50° C. Ammoniumhydroxide solution (32 wt. %, 74.78 mmol) was added to obtain the first mixture. The mixture was stirred further until it reached 50° C. again. Then, a mixture of tetraethoxysilane (TEOS)(47.5 mmol) and tetramethoxysilane(TMOS) (2.5 mmol) preheated to 50° C. was quickly added to the first mixture in one portion under vigorous stirring to obtain the reaction mixture with an ROR of 0.75. Stirring was continued for 10 seconds, then stopped. The reaction mixture was kept overnight at 50° C.

The dispersion was stirred and 50 mmole deionized water were added slowly, followed by 8 h stirring at 50° C. The particles had a Mean particle size of 91.2 nm, and polydispersity index (PDI) of 0.078, measured by Dynamic Light Scattering (DLS).

### Example 2: Synthesis of Elongated Particles (10% TMOS, 90% TEOS, ROR 0.75)

12346.97 mmol ethanol was heated under stirring to 50° C. Ammoniumhydroxide solution (32 wt. %, 747.36 mmol) was added to obtain the first mixture. The mixture was stirred further until it reached 50° C. again. Then, a mixture of tetraethoxysilane (TEOS) (451.17 mmol) and tetramethoxysilane (TMOS) (50.07 mmol) preheated to 50° C. was quickly added to the first mixture in one portion under vigorous stirring to obtain the reaction mixture. Stirring was continued for 10 seconds, then stopped. The reaction mixture was kept overnight at 50° C. The particles had a Mean particle size of 66.5 nm, PDI of 0.086, measured by DLS.

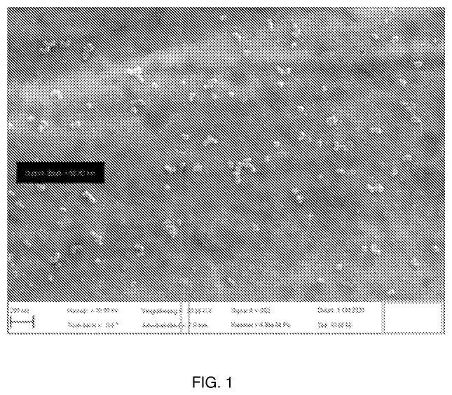

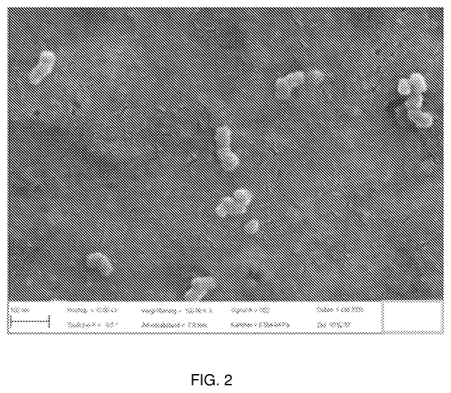

FIGS. 1 and 2 are SEM micrographs showing the non-spherical primary silica nanoparticles produced by Example 2.

### Example 3: (TEOS:TPOS 80:20, ROR 0.75)

1234.7 mmol ethanol are heated under stirring to 50° C. Ammoniumhydroxide solution (32 wt. %, 70.11 mmol) was added to obtain the first mixture. The first mixture was stirred further until it reached 50° C. again. Then, a mixture of tetraethoxysilane (TEOS) (40.06 mmol) and tetrapropoxysilane (TPOS) (10.02 mmol) preheated to 50° C. was quickly added in one portion to obtain the first mixture under vigorous stirring to obtain the reaction mixture. Stirring was continued for 10 seconds, then stopped. The reaction mixture was kept overnight at 50° C. The particles had a Mean particle size of 50.0 nm, and PDI of 0.051, measured by DLS.

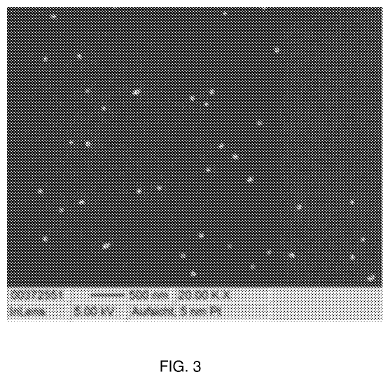

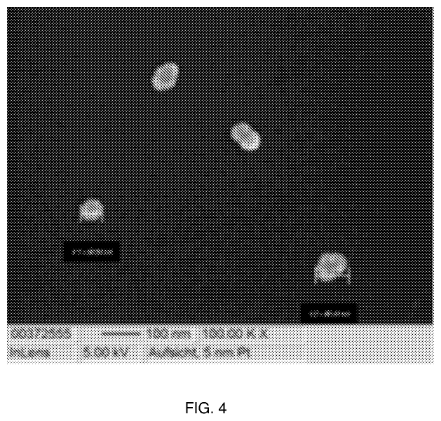

FIGS. 3 and 4 are SEM micrographs showing the non-spherical primary silica nanoparticles produced by Example 3.

### Example 4: (60% TEOS, 40% TPOS, ROR 0.75)

1234.7 mmol ethanol are heated under stirring to 50° C. Ammonium hydroxide solution (32 wt. %, 74.78 mmol) was added to obtain the first mixture. The mixture was stirred further until it reached 50° C. again. Then, a mixture of tetraethoxysilane(TEOS) (30.50 mmol) and tetrapropoxysilane (TPOS) (20.50 mmol) preheated to 50° C. was quickly added to the first mixture in one portion under vigorous stirring to obtain the reaction mixture. Stirring was continued for 10 seconds, then stopped. The reaction mixture was kept overnight at 50° C. The particles had a Mean particle size of 53.5 nm, and PDI of 0.053, measured by DLS.

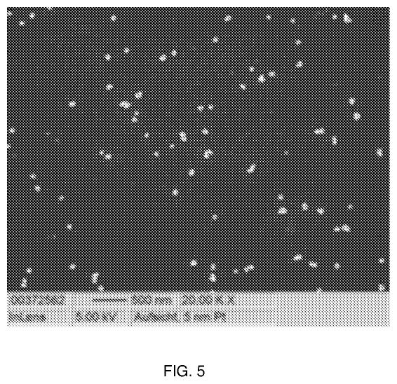

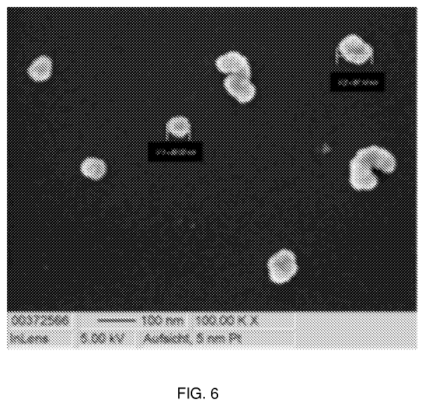

FIGS. 5 and 6 are SEM micrographs showing the non-spherical primary silica nanoparticles produced by Example 4.

### Example 5: Ion Exchange and pH Shift to Acidic pH

1247.1 g nanoparticle dispersion from example 2 was stirred and 700 g ion exchanger Amberlite IRN-150 was added. Stirring was continued for 1 hour before the ion exchanger was filtered off. pH was measured with a pH electrode to be 4.3. HNO₃ (1%) was added slowly until the pH of the dispersion was 2.0.

### Example 6: Surface Modification, Zeta-Potential Adjustment and Solvent Transfer

42.44 mmol (3-aminopropyl)trimethoxysilane was diluted with 3.61 mol methanol. Under vigorous stirring, concentrated nitric acid (65 wt. %, 46.7 mmol) was added quickly to the solution. Stirring was continued for 1 minute.

The ion exchanged and acidified particle dispersion of example 5 was stirred vigorously and the above freshly prepared acidified aminosilane solution was added quickly. Stirring was continued for 1 h at room temperature and then the dispersion was heated to 70° C. and stirred for another 2 hours at that temperature.

The dispersion was then transferred to a rotary evaporator and alcohols were removed stepwise and replaced by adding water until the dispersion reached a solid content in water of 21.5 wt. %.

Finally, the dispersion was filtered through a 2 μm glass fiber filter.

The particles had a mean particle size of 90.5 nm, PDI of 0.058 by DLS, and zetapotential: 40.3 mV, at pH 2.2.

### Example 7: Synthesis of Elongated Particles (90% TEOS, 10% TMOS, ROR 0.75) with a Second Growth

32.35 mol absolute ethanol were mixed with 1.58 mole tetraethoxysilane and 0.18 mole tetramethoxysilane to obtain a first mixture. The first mixture was stirred and heated to 66° C. Under vigorous stirring, 2.63 mole of ammonia solution (32%) was added quickly and stirring was continued for 10 s then stopped. Temperature dropped to 60° C.

The reaction mixture was kept at 60° C. for 12 h then particle size was measured by DLS. The particles had a mean particles size of 77.7 nm, and PDI of 0.054.

25.53 mole deionized water was heated to 60° C., then slowly added under stirring to the reaction mixture which still had a temperature of 60° C. Stirring was continued for 30 minutes at 60° C. Then, tetraethoxysilane (1.67 mole) was added over the course of 3 h with a dosimeter pump while stirring was continued. The mixture was finally stirred for 12 h at 60° C. and then particle size distribution was measured with DLS. The particles had a mean particle size of 89.3 nm, and PDI of 0.047.

### Comparative Example 1 (100% TEOS—not Inventive)

A mixture of absolute ethanol (1,201.27 mmole) and tetraethoxysilane (TEOS) (50.00 mmole) was heated to 55° C. under stirring. Ammoniumhydroxide solution (32%, 74.78 mmole) was added quickly under vigorous stirring. The temperature dropped to 50° C. Stirring was continued for 10 seconds, then switched off and the reaction mixture was kept for 12 h at 50° C. before particle size distribution was measured with DLS.

The particles had a Mean particle size of 47.4 nm, and PDI of 0.025.

The very low PDI is an indicator that the particles are hardly elongated or non-spherical and therefore are not favorable regarding the requirement profile.

### Example 8: Nitrogen Level (or Nitrogen Content)

Nitrogen level or nitrogen content in the non-spherical primary silica particles made in the present invention as shown in the previous examples 1 and 2, was measured by dissolving the dried non-spherical primary silica particles in KOH and the nitrogen species were then measured by ion chromatography. Prior to drying the particles, the dispersion medium was freed from nitrogen-containing species by cross-flow filtration.

Results were shown in Table 1.

TABLE 1

| Silica abrasive | Nitrogen level (mmol/g SiO₂) |
|---|---|
| Example 1 | 0.0041 |
| Example 2 | 0.0058 |

As it is apparent from the results presented in Table 1, even though a concentrated solution of ammonia is used as a catalyst in the reactions, the level of nitrogen in the non-spherical primary silica particle is extremely low, and is in the range of 0.0041 to 0.0058 mmol/g SiO₂.

This nitrogen content is about 50 times less than the nitrogen content incorporated in the silica particles as disclosed in U.S. Pat. Nos. 9,422,456 and 949,972, where the nitrogen content was measured by the same method.

The nitrogen content in non-spherical primary silica particles made in current application is below the nitrogen content (<0.02 mmol/g SiO₂) measured from the particles used as controls in U.S. Pat. Nos. 9,422,456 and 949,972.

The foregoing examples and description of the embodiments should be taken as illustrating, rather than as limiting the present invention as defined by the claims. As will be readily appreciated, numerous variations and combinations of the features set forth above can be utilized without departing from the present invention as set forth in the claims. Such variations are intended to be included within the scope of the following claims.

1. A process of synthesizing non-spherical primary silica nanoparticles comprises:
a) providing a mixture of at least two organoalkoxysilanes, wherein each organoalkoxysilane independently has a structure represented by Formula I: 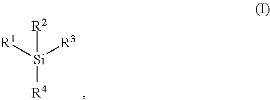
wherein
R¹, R², R³, and R⁴ are each independently selected from the group consisting of OR or R, wherein R is a substituted or unsubstituted linear or branched C₁-C₁₂ alkyl group, a C₃-C₈ cycloaliphatic group, a C₂-C₆ alkylene group, a halogen, or an aryl group, and at least two, preferably at least three of R¹, R², R³, and R⁴ are OR;
wherein at least one of the at least two organoalkoxysilanes has at least three of, preferably all, R¹, R², R³, and R⁴ as OR; and
the at least two organoalkoxysilanes have different reaction speeds with water under alkaline conditions;
b) providing a water-miscible organic solvent;
c) providing an alkaline catalyst;
d) obtaining a reaction mixture comprising a) to c); wherein the reaction mixture contains water and has a molar ratio (ROR) of water (H₂O) and hydrolysable groups (OR) on the at least two organoalkoxysilanes greater than 0, and below 3.0, or below 2.0; such as from 0.5 to 1.5, according to a formula: ROR=M(H₂O)/M(OR);
e) forming non-spherical primary silica nanoparticles by reacting the at least two organoalkoxysilanes with the water in the reaction mixture under an alkaline condition;
and
optionally,
f) replacing at least a portion of the water-miscible organic solvent by water after the non-spherical primary silica nanoparticles are formed to obtain a non-spherical primary silica nanoparticles dispersion; and
g) adding water in step d) if there is not enough water from a) to c) to meet the ROR in step d).

2. The process of claim 1 wherein the non-spherical primary silica nanoparticles have shapes selected from the group consisting of elongated, bent, branched, and combinations thereof; and contain a nitrogen level of <0.1, or <0.01, mmol/g SiO₂.

3. The process of claim 1 wherein step d) can be performed by (1) adding the water-miscible organic solvent into the mixture of at least two organoalkoxysilanes to obtain a first mixture, and adding the alkaline catalyst into the first mixture; (2) adding the alkaline catalyst into the water-miscible organic solvent to obtain a first mixture, and adding the mixture of at least two organoalkoxysilanes into the first mixture; or (3) adding the water-miscible organic solvent into the mixture of at least two organoalkoxysilanes to obtain a first mixture, adding the water-miscible organic solvent into the alkaline catalyst to obtain a second mixture, and mixing the first and the second mixtures in a mixer in a flow reactor.

4. The process of claim 1 wherein the first mixture and the reaction mixture are heated and maintained at a temperature from 30° C. to 70° C., or from 48° C. to 52° C.

5. The process of claim 1 wherein the process is carried out in a closed vessel optionally under moderate pressure or a flow reactor.

6. The process of claim 1 wherein each of the at least two organoalkoxysilanes is selected from the group consisting of tetramethoxysilane, tetraethoxysilane, tetraisopropoxysilane, tetrabutoxysilane, tetraoctoxysilane, methyltrimethoxysilane, methyltriethoxysilane, methyltriisopropoxysilane, ethyltrimethoxysilane, ethyltriethoxysilane, ethyltriisopropoxysilane, octyltrimethoxysilane, octyltriethoxysilane, vinyltrimethoxysilane, vinyltriethoxysilane, phenyltrimethoxysilane, phenyltriethoxysilane, triethylmethoxysilane, fluorotriisopropoxysilane, fluorotrimethoxysilane, fluorotriethoxysilane, dimethyldimethoxysilane, dimethyldiethoxysilane, diethyldimethoxysilane, diethyldiethoxysilane, trimethylmethoxysilane, trimethylethoxysilane, trimethylisopropoxysilane, trimethylbutoxysilane trifluoromethyltrimethoxysilane, and trifluoromethyltriethoxysilane.

7. The process of claim 1 wherein two organoalkoxysilanes are used in the mixture of at least two organoalkoxysilanes and one of the organoalkoxysilane is present from about 50 to about 99 mole % and the other organoalkoxysilane is present at from about 50 to about 1 mole %.

8. The process of claim 1 wherein the at least two organoalkoxysilanes comprise tetramethoxysilane and tetraethoxysilane, and the tetramethoxysilane is present at from about 2 to about 25 mole % or 7.5 to 12.5 mole % based on total molar of the at least two organoalkoxysilanes.

9. The process of claim 1 wherein the at least two organoalkoxysilanes comprise tetramethoxysilane and tetraethoxysilane, and the molar ratio (ROR) of water (H₂O) and hydrolysable groups (OR) on the at least two organoalkoxysilanes is 0.75.

10. The process of claim 1 wherein the alkaline catalyst is selected from the group consisting of ammonia (NH₃), ammonium hydroxide, an organic amine, an alkanolamine, a quaternary ammonium hydroxide compound, and combinations thereof.

11. The process of claim 1 wherein pH of the reaction mixture is from 7 to 14, or 10 to 14.

12. The process of claim 1 wherein the alkaline catalyst comprises NH₃ or an organic amine and the reaction mixture is at a pH of greater than 8 or greater than 9.

13. The process of claim 1 wherein step (d) occurs in a continuous flow reactor or a batch reactor.

14. The process of claim 1 wherein the replacing step f) comprises adding water in an amount to achieve a molar ratio (ROR) of water (H₂O) and hydrolysable groups (OR) on the organoalkoxysilanes (ROR) greater than or equal to 1.0 or greater than or equal 2.0.

15. The process of claim 1 further comprising a second growth step of adding an organoalkoxysilane and water and optionally an alkaline catalyst to the reaction mixture immediately after step d).

16. The process of claim 1 wherein the replacing step f) comprises at least one of distillation and membrane filtration.

17. The process of claim 1 further comprising a step of changing the pH of the non-spherical primary silica nanoparticles dispersion obtained in step f) from alkaline to acidic by passing the dispersion through an ion exchanger and optionally adding an acid.

18. The process of claim 1 further comprising the step of modifying surface of the non-spherical primary silica nanoparticles by treating the surface with a surface-modifying agent selected from the group consisting of an organosilane, an organic polymer, an inorganic polymer, a surfactant, an inorganic salt, metal ions, and combinations thereof.

19. The process of claim 18 wherein the organosilane used to modify the surface is selected from the group consisting of an amino-functional alkyl-alkoxysilane, a cyano-functional alkyl-alkoxysilane, an alkyl- and aryl-functional alkoxysilane, sulfur-containing silanes, carboxy-group containing silanes, phosphorous-containing silanes, alkyl silanes, and combinations thereof.

20. The process of claim 1, wherein the non-spherical primary silica nanoparticles is produced at a weight % yield of 3.0 wt. %-8.0 wt. %, or 4.5 wt. %-6.5 wt. %, based on the total weight of silica nanoparticles which can be produced by total weight of the reaction mixture.

21. The process of claim 1, wherein the non-spherical primary silica nanoparticles is produced at a yield of at least 50%, or 75% based on total weight of particles.

22. Non-spherical primary silica nanoparticles, wherein the non-spherical primary silica nanoparticles have shapes selected from the group consisting of elongated, bent, branched, and combinations thereof; and contain a nitrogen level of <0.1, or <0.01 mmol/g SiO₂.

23. Non-spherical primary silica nanoparticles, wherein the non-spherical primary silica nanoparticles have shapes selected from the group consisting of elongated, bent, branched, and combinations thereof; and contain a nitrogen level of <0.1, or <0.01, mmol/g SiO₂; wherein the non-spherical primary silica nanoparticles are prepared by the process of claim 1.

24. A Chemical Mechanical Planarization (CMP) composition comprising:
the non-spherical primary silica nanoparticles of claim 22; <0.1,
and optionally at least one selected from the group consisting of colloidal stabilizer, soluble or solid catalyst, chelating agent, corrosion inhibitor, surfactant, biocide, organic or inorganic salts, and pH adjuster.

25. (canceled)

26. A Chemical Mechanical Planarization (CMP) composition comprising:
the non-spherical primary silica nanoparticles prepared by the process in claim 1;
and optionally at least one selected from the group consisting of colloidal stabilizer, soluble or solid catalyst, chelating agent, corrosion inhibitor, surfactant, biocide, organic or inorganic salts, and pH adjuster.

27. (canceled)
